(19) United States
(12) Patent Application Publication
(10) Pub. No.: US 2005/0141974 A1
(43) Pub. Date: Jun. 30, 2005

(54) Trimming device

(76) Inventor: Josef Jaegg, Berkheim (DE)

Correspondence Address: JACOBSON, PRICE, HOLMAN & STERN;PROFESSIONAL LIMITED LIABILITY COMPANY, 400 Seventh Street, N.W., Washington, DC, 20004, US

(21) Appl. No.: 11/001,095

(22) Filed: Dec. 2, 2004

(30) Foreign Application Priority Data
Dec. 4, 2003 (DE) 203 18 942.6

(51) Int. Cl. B23C 3/00

(52) U.S. Cl. 409/138; 409/139; 409/192

(57) ABSTRACT

Trimming device for frames or frame parts consisting of welded synthetic profiles for windows, doors or the like, the trimming device having a rotating, chip removing tool designed as profile milling cutter which serves for removing the welding bead projecting on the weld seam of the synthetic profile.

The invention refers to a trimming device for frames or frame parts consisting of welded synthetic profiles for windows, doors or the like, the trimming device having a rotating chip removing tool which serves for removing the welding bead projecting on the weld seam of the synthetic profile.

### BACKGROUND OF THE INVENTION

Trimming devices of the type described in the beginning are used for removing the outward projecting welding bead which occurs on the weld seam as a consequence of a butt welding process. During butt welding here the synthetic profiles cut mitred are, for example, welded to a window or door frame or the like. As the synthetic profiles are cut mitred, also the plane of the weld seam runs at a corresponding mitre angle. If, for example, synthetic profiles are welded to each other rectangular, the mitre joint is 45° to the other adjacent frame parts welded to each other.

In the state of the art, for example, the European Patent 350 832 has become known. Here an external corner trimming device for window frames or the like is described. A circular saw blade is used here as chip removing tool. Furthermore a touch device is provided which is connected with a control. The touch device has for that purpose a tracer which is movable with the circular saw blade and relatively, axially to it, which traces the frame. For that purpose the tracer traces the window frames on a tracing point which is in the plane of the circular saw blade, and is dislocated laterally towards the window frame with regard to the working spot. By means of that an excursion in the plane of the frame and vertically to that a radial, respectively axial, movement of the circular saw blade is triggered by the tracers.

Eventually in the state of the art the contour is traced with tracers, and a circular saw blade is controlled because off the position of the tracers.

Such a process may perhaps be used with comparatively rough profile contours because, of course, the limited width of the circular saw blade as well as the limited width of the tracers defines eventually the accuracy of the machining. More detailed profiles, however, are optically damaged by such a process or the welding bead is not removed completely. This is not desired.

Furthermore it has to be considered that the tracing is not carried out actually on the welding bead but dislocated laterally. This has the result that actually not the shape of the surface, respectively the contour, in the region of the mitre joint is scanned but a shape of the contour which is located laterally next to it and maybe, for example, corresponds with the cross section surface (a rectangular section). This leads to inaccuracies of dimensions.

Finally also the design with the tracers is contradictory, as for a result as accurate as possible the tracers have to be shaped very small and detailed in order to follow the shape of the contour optimally, however, on the other hand it has to be taken into consideration that the tracers are connected with an arrangement which has a considerable mass. During an unintended approach of the complete arrangement the tracers may possibly be damaged easily. Furthermore it has to be taken into consideration that tracing has to be carried out permanently, that is also during the chip removing machining, and that flying chips may fall possibly in the gap between tracer and the profile and therefore the result of tracing falsify and, of course, leading to the result that also the machining may not succeed.

### BRIEF ABSTRACT OF THE INVENTION

It is an object of the invention to improve a trimming device as described in the beginning in such a way that the machining result of removing the welding bead is improved.

In order to solve this problem the invention comes from a trimming device as described in the beginning and suggests that a profile milling cutter is used as tool the contour of which corresponds with the shape of the surface of the synthetic profile in the region of the weld seam.

The invention proposes that instead of a circular saw blade a profile milling cutter is used. The profile milling cutter is designed here in such a way that its contour corresponds with the shape of the surface of the synthetic profile in the region of the weld seam and thus is fitted optimally. It has been considered here that in the region of the weld seam the synthetic profiles are butt-welded with a mitre angle and the shape of the surface in the region of the weld seam does not necessarily correspond with the cross section of the synthetic profile. Thus the tool is not adjusted exactly to the desired shape of the surface resulting automatically in a very high optical quality of the machining of the weld seam which cannot be achieved with circular saw blades because of the limited width of the circular saw blades.

The direct result is an improvement of the outcome when the trimming device according to the invention is used.

The two synthetic profiles which have to be welded to each other already form a plane between themselves which will, after that, correspond with the plane of the frame. In the sense of the invention therefore the plane is to be understood as plane of the frame which is defined by at least two synthetic profiles, respectively frame parts, respectively frames, welded to each other.

Of course, the invention includes also frame parts by the term frame which are, for example, welded by only two synthetic profiles, for example, because these elements are, after that, to be connected in the combination with other frame parts or frames. Therefore in the sense of the invention also parts of the frame, at least consisting of two synthetic profiles welded to each other, have to be understood as frames.

Therefore the invention is preferably used for removing the welding bead on the external corner of two angular welded synthetic profiles. However, the invention is not limited to it. The invention may also be used with two butt, not angular welded synthetic profiles on both sides of the synthetic profile. In particular the visible frame region of the overlapping in the region of the mitre joint is machined optimally by the invention.

The contour of the profile milling cutter corresponds with the desired shape of the surface of the synthetic profile. The contour may follow a continuously running line. However, according to an embodiment of the invention it is provided that the profile milling cutter has graduations along its rotational axis. Each of these graduations may be shaped in equally large steps. According to a modification of the invention the graduations are selected in differing sizes.

This offers the opportunity to adjust the profile milling cutter to the differing shape of the surface of the synthetic profiles. Projections on the profile milling cutter add to the design of shape. Projections on the milling cutter create, for example, recesses, respectively cuts, on the profile.

Not only a continuous or graduated shape of the surface of the profile milling cutter is a possibility but also the combination of continuous and graduated shape. A continuous shape can follow a straight or bent path, where the straight line is arranged parallel or angular with regard to the rotational axis. The bent path can follow a circle, a bent or a curved line. Even other than the shapes mentioned here for the surface of the profile milling cutter are not excluded.

For machining the synthetic profile the surface of the profile milling cutter is provided with chip removing cutting edges. At least two cutting edges rotate on flying circles with different diameters the rotational axis of the profile milling cutter. These two cutting edges are arranged, according to an embodiment of the invention, on two discs with different diameters. The profile milling cutter comprises, according to another embodiment of the invention, a number of discs each of them carrying at least one cutting edge. The cutting edges themselves are partly formed straight or bent. Together they form the contour of the surface of the profile milling cutter with its graduations, projections or bent lines. One advantage of such a profile milling cutter is the fact that the single discs may be combined, if necessary, differing. It is also easily possible to replace a disc if its worn. This reduces the non-productive time of the machine during production.

It is also provided to combine the profile milling cutter not from single discs but from one-piece, rotatory basic bodies with graduations or projections. The chip removing cutting edges are arranged on its circumference. At least each step is assigned at least one cutting edge. The projections are also formed by cutting edges, the width of them being, if necessary, smaller than the one of the other cutting edges.

In a preferred embodiment of the invention it is provided that the trimming device has two stoppers arranged angular, preferably rectangular, and each of the synthetic profiles of the frame sits close to a stopper.

Usually rectangular frames are manufactured which still have to be machined with the trimming device. However, it is also possible to use any other angle in a frame, and, after that, to use the invention for removing the projecting welding bead, where the trimming device then has two stoppers arranged angular which form an angle which usually corresponds with the double mitre angle. The stopper here has a surface which is large enough that it sits securely and tight to the respective synthetic profile. The stopper is designed here accordingly large so that, even if the trimming device is approached with a certain impulse to the synthetic profile, the stopper remains accurate and is not damaged. The stopper here already sets the relative position of the profile milling cutter to the area which has to be machined.

Besides the modification that the trimming device carries the stoppers, according to another modification of the invention it is provided that the frame is supported on a working table and the working table has two stoppers arranged angular, preferably rectangular, and each of the synthetic profiles of the frame sits close to a stopper. In this modification the trimming device is adjusted exactly with regard to the position of the stoppers on the table and the arrangement of additional stoppers on the trimming device is not necessary in this modification.

Furthermore the invention suggests that the trimming device has a down-holding device which acts essentially rectangular to the plane of the frame. In particular in combination with the two rectangular arranged stoppers it is achieved by that that the trimming device can be positioned accurately with regard to the three space coordinates relatively to the region of the weld seams which have to be machined. Here preferably the two stoppers act in the plane of the frame or in a plane parallel to it, the down-holding device here acts stopper-like rectangular. If necessary the down-holding device serves also for pressing the frame exactly on a surface.

Alternatively to that a down-holding device acting essentially rectangular to the plane of the frame is provided on the working table.

Basically the invention here offers two alternatives. The arrangement of the stoppers, respectively of the down-holding device is, in the first modification, arranged on the trimming device, and, in the other modification, on the working table. Eventually, however, the exact adjustment of the stoppers and the down-holding device with regard to the profile milling cutter is decisive for a fully satisfying working result. The advantage of the arrangement of the stoppers and the down-holding device on the trimming device is in particular the fact that the exact clamping of the frame on the working table is not decisive as the trimming device searches, finds and machines the respective machining position for removing the welding bead exactly by itself by means of the three spots, the two stoppers and the down-holding device. If necessary, however, suitable sensors for the exact fitting of the frame on the stoppers are provided in the stoppers in order to reach also with the other modification the highest machining quality.

In a preferred arrangement of the invention it is provided that the rotational axis of the profile milling cutter is orientated rectangular to the plane of the frame. Such an embodiment allows arranging the rotational drive above the frame where it does not obstruct. It is, of course, possible here to orientate the rotational axis of the profile milling cutter even angular, respectively parallel, to the plane of the frame, the profile milling cutter will then be designed differently.

For positioning the trimming device accurately it is provided that it can be moved rectangular to the plane of the frame as well as parallel the plane of the frame. If, in particular, the trimming device is equipped with stoppers and down-holding device, the exact position of the welding connection which has to be machined is not significant, as the trimming device hits the respective machining position exactly because of the guide by means of the stoppers and the down-holding device. Mobility with regard to the plane of the frame and rectangular to it is here a possibility, another possibility is to move the trimming device along other orientated axes in the space. This also is included in the invention.

It is an advantage here that the trimming device can be moved along the rotational axis, this being, in a modification of the invention, also simultaneously rectangular to the plane of the frame.

In a preferred embodiment of the invention it is provided that the position of the profile milling cutter with regard to the stoppers, respectively the down-holding device, may be adjustable, however, during the use of the trimming device, determined. By means of the adjustability with regard to the stoppers, respectively the down-holding device, the profile milling cutter is orientated in its machining position with regard to the edges of the profile, respectively their overlap, that are the surfaces respectively edges which interact with the stoppers, respectively the down-holding device, in order to get an optimal machining result.

In another modification of the invention it is provided that the profile milling cutter can be moved relatively to the down-holding device. In this modification according to the invention the down-holding device serves in particular for fixing the frame, in particular before the actual chip removing machining. The profile milling cutter can then be moved rectangular to the plane of the frame, the active direction of the down-holding device, and then has a suitable stopper in order to remove the welding bead fitting exactly. Therefore it is convenient that the profile milling device can be moved on the trimming device, in particular can be positioned. Thus the profile milling cutter can be moved relatively to the trimming direction in a modification according to the invention, or it is, in another modification, determined in that respect and can be positioned and moved only by the movement of the trimming device altogether.

A smart way to use the down-holding device as a fixing element for the frame as well as a stopper for the movement of the profile milling cutter in the direction of the welding bead which has to be removed is the modification that the down-holding device is held supported by springs on the trimming device. By means of the spring force the frame is, first of all, held by the down-holding device, while there, if necessary, no machining yet is carried out by the profile milling cutter. However, the mobility of the down-holding device is limited, the lowest machining position of the profile milling cutter on the frame corresponding with the spring-supported movement of the down-holding device on the final stopper.

Therefore the invention shows several modifications how the trimming device with the profile milling cutter according to the invention can be used.

It is an essential advantage that, according to the invention, first of all the frame is put at the stoppers, the down- holding device fixes the frame and, after that, the profile milling cutter removes the welding bead. As the stopper, respectively the down-holding device has a large surface they do not act as tracers for tracing the exact shape, but they determine the position of the trimming device with regard to the welding bead which has to be machined. This determination is conveniently carried out here before the actual chip removing machining, reducing considerably the risk that a jammed chip obstructs the exact positioning and thus also obstructing the accurate machining.

Of course, in another modification according to the invention air flushing, for example by suitable air nozzles, may be provided to reduce this risk furthermore.

According to this example it is also provided that the stoppers are arranged on the trimming device as well as on the machine table.

In another modification, also according to the invention, it is suggested that the trimming device can be moved, first of all, in a direction parallel to the plane of the frame in order to approach the stoppers arranged on the trimming device to the synthetic profiles of the frame until they sit close, and, after that, the trimming device can move rectangular to the plane of the frame, and the profile milling cutter removes the welding bead until the down-holding device is supported by the frame. In this very simple, however effective and also economic, embodiment of the invention all advantages of the invention are realised. A reliable working result is achieved, the exact position of the frame on the working table being not decisive as the trimming device is positioned by the mobility in such a way that both stoppers sit close to the synthetic profile.

The problem according to the invention is also solved by a trimming machine for synthetic frames which is provided for removing of projecting welding beads which form at the weld seam of welded synthetic profiles, the trimming machine for synthetic frames using a trimming device as described above. The trimming device is here a part of a more complex trimming machine for synthetic frames as it is used for removing, respectively polishing, the welding beads after welding the synthetic profiles into a frame. Therefore the invention cannot only be realised in a single device, but achieves, in particular in combination with other elements, advantages, as the simple design is not prone to malfunctions, and therefore leads to a reliable machine, and, on the other hand, because of the fast machining, leads to higher performances.

### BRIEF DESCRIPTION OF THE DIFFERENT VIEWS OF THE DRAWINGS

The invention is shown schematically in the drawing. In the drawings:

FIGS. 1, 2 each one a three dimensional view of the invention in use, and

FIG. 3 in another three dimensional view the invention before use.

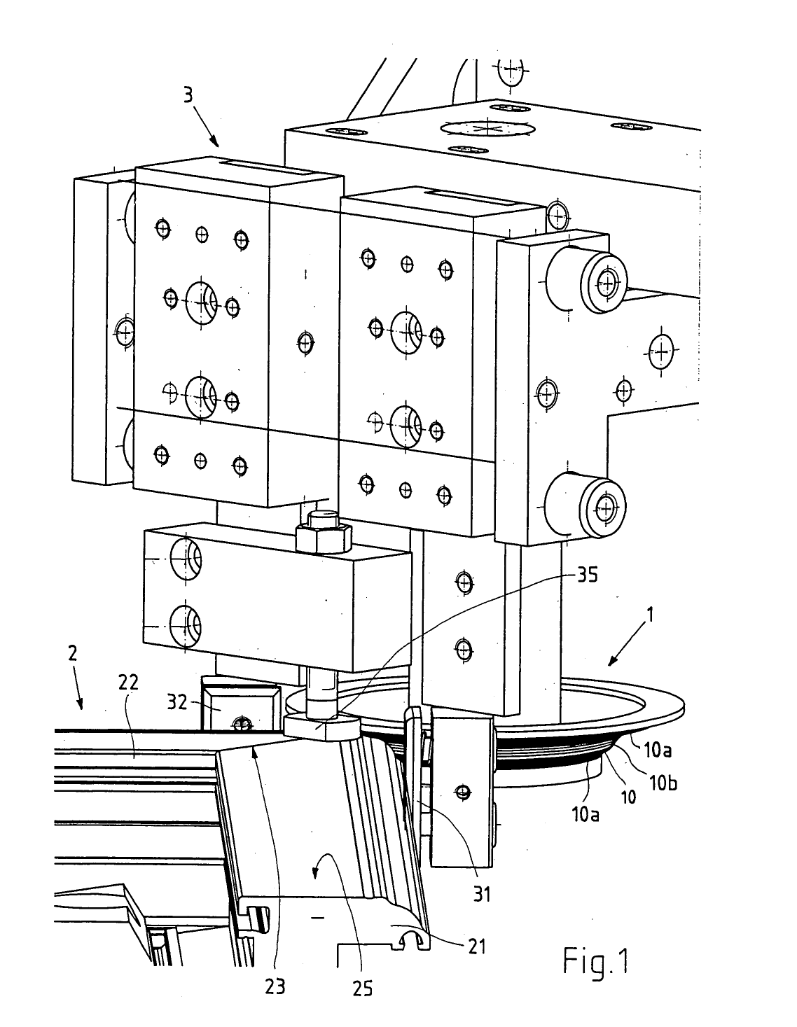

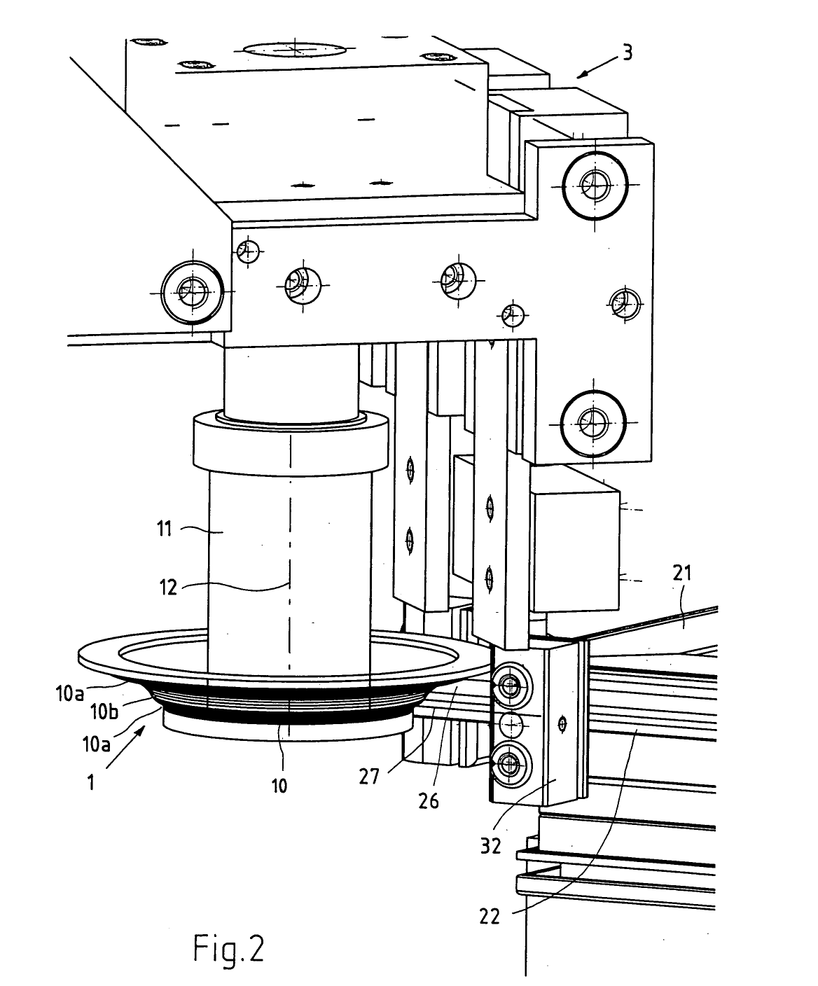

In FIG. 1 the trimming device 3 according to the invention is shown in use. A welding bead 24 in the region of the weld seam 23 is already removed in the position shown here.

The trimming device 3 comprises an arm which can move on a machine frame (not shown) which carries on its bottom end facing the frame 2 two stoppers 31, 32, a down-holding device 35 as well as the tool 1 designed as profile milling cutter 10. The drive shaft 11, for example, is set in rotation via a belt drive through a driving motor.

In the following often a frame 2 is mentioned which also has to be interpreted as frame part 2 in the same sense as the invention can already be used with two connected synthetic profiles 21, 22. For clearness sake, however, only the concerned corner region is shown here, however, the invention can also be used for a frame 2 as well as for frame parts.

The synthetic profiles 21, 22 are welded angular, in particular rectangular. For that purpose they are, first of all, cut mitred and welded at the weld seam 23. Because of the assembly process during the manufacturing of the frame 2 a welding bead 24 projecting outward is formed along the weld seam 23, which has to be removed as optically neutrally as possibly. In particular for the external corner region 27 the trimming device according to the invention is provided, although it is not restricted in its use to that.

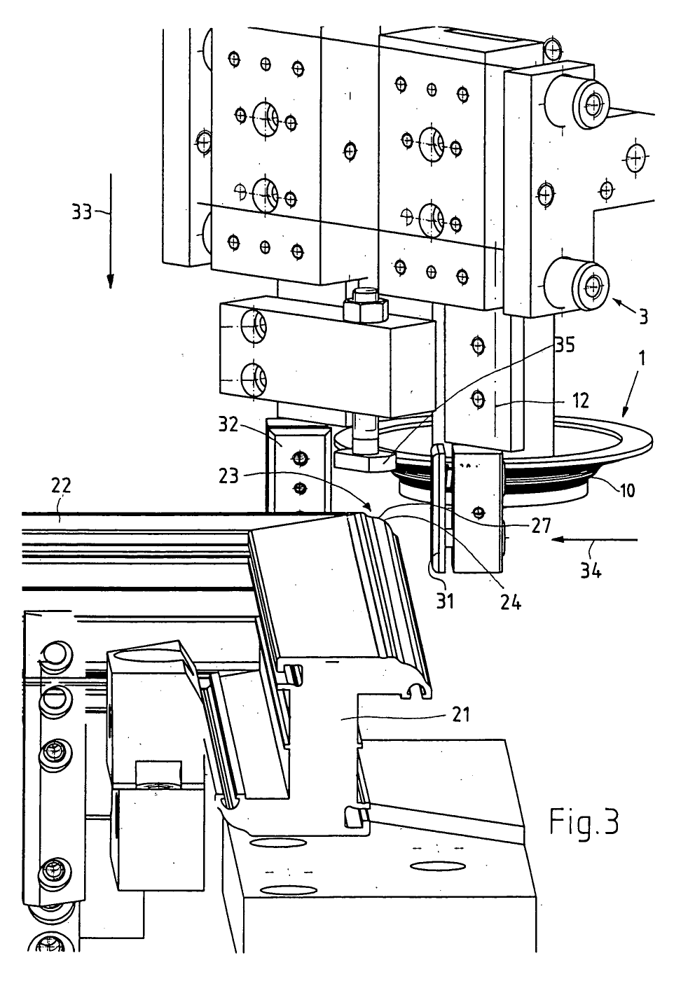

In FIG. 3, first of all, the arrangement before machining is shown. In the region of the weld seam 23 at least in the external corner region 27 there is the welding bead 24 which has to be removed.

The trimming device can be moved in two directions 33, 34 rectangular to each other. Conveniently one component of motion is here parallel (arrow 34) to the plane of the frame defined by the frame, respectively the frame parts assembled by the synthetic profiles 21, 22, and the other component of motion is rectangular (indicated by arrow 33) to it. For the movement in both directions 33, 34 working cylinders working preferably pneumatically are provided, which may serve, if necessary, simultaneously as absorbers during approaching the stoppers/down-holding device to the frame. The drive may, however, also be realised in another way, for example by electromotors and the like.

The trimming device carries on its bottom end two stoppers 31, 32 arranged angular to each other. The angular arrangement of the stoppers 31, 32 here corresponds with the angle by which the synthetic profiles 21, 22 in the frame 2 are welded.

First of all the trimming device is approached along arrow 34, that is parallel to the plane of the frame, until both stoppers 31, 32 sit close to the respective synthetic profile 21, 22. Conveniently here a direction of the component of motion 34 is chosen which results in an approach of the first stopper 31 as well as of the second stopper 32 to the frame 2. For example, the component of motion 34 is provided parallel to the mitre surface, respectively the weld seam 23.

If the stoppers 31, 32 sit close to the synthetic profiles 21, 22, as a rule, the trimming device 3 is still too high, and, therefore, the profile milling cutter 10 not yet in engagement with the frame. In the second step, then a motion along the motion component 33 (rectangular to the first component of motion 34) is carried out, that means the trimming device 3 is lowered until the down-holding device 35 is supported by the surface 25 of the frame.

Here the arrangement of the profile milling cutter 10 with regard to the down-holding device 35 as well as to the two stoppers 31, 32 is chosen in such a way that, if the down-holding device 35 and the stoppers 31, 32 interact on the frames, respectively with the synthetic profiles, that is sit close to them, the profile milling cutter 10 removes exactly the projecting welding bead 24. For that purpose it is provided that this position can be, of course, adjusted accordingly in order to reach the desired working result.

In this process the down-holding device 35 acts as another stopper in the direction of the movement of the component of motion 33.

As the weld seam 23 runs along the mitre surface which runs at an angle, as a rule, half of the connection angle of the two synthetic profiles, the external contour, respectively the shape of the surface 26 of the profiles 21, 22, does not correspond in the region of the weld seam with the contour of the cross section of the profile. The design of the profile milling cutter 10, however, is created in such a way that it corresponds with the shape of the surface 26 of the synthetic profile 21, 22 in the region of the weld seam 23. By means of that an optimal removal of the welding bead 24 projecting above the weld seam 23 is possible without further damaging the surface.

The shape of the contour of the profile milling cutter 10 which corresponds with the shape of the surface 26 of the synthetic profile 21, 22 in the region of the weld seam is formed by an arrangement of cutting edges at the circumference of a basic body forming the profile milling cutter 10. The basic body has, corresponding with the shape of the surface 26 of the synthetic profile 21, 22, graduations 10a and/or projections 10b on its circumference so that the thickness of the basic body differs over its length. At least one cutting edge is assigned each section of the basic body, the cutting edge having here a straight or a bent edge. A straight edge of the cutting edge causes also a straight edge in the region of the external corner 27 of the synthetic profile 21, 22, and a bent cutting edge a curved edge. By means of the design of the cutting edges the contour of the external corner connection 27 can be profiled exactly.

According to a modification of the invention not shown the basic body is assembled by single discs with differing diameters. Each disc carries at least one cutting edge which machines the synthetic profile 21, 22. Advantageously, the cutting edges are arranged over the complete circumference of the basic body, respectively the discs, so that a continuous removal of the welding bead 24 is secured.

It is provided that on the trimming device 3 a driving motor is provided for the profile milling cutter 10. The driving motor sets the profile milling cutter 10 in rotation around the rotational axis 12 which, in this example, extends vertically, respectively rectangular, to the plane of the frame.

Although the invention has been described by exact examples which are illustrated in the most extensive detail, it is pointed out that this serves only for illustration and that the invention is not necessarily limited to it because alternative embodiments and methods become clear for experts in view of the disclosure, Accordingly changes can be considered which can be made without departing from the contents of the described invention.

1. Trimming device for frames or frame parts consisting of welded synthetic profiles for windows, doors or the like, the trimming device having a rotating, chip removing tool which serves for removing the welding bead projecting on the weld seam of the synthetic profiles, characterised in that as tool (1) a profile milling cutter (10) is provided, the contour of which corresponds with the shape of the surface (26) of the synthetic profile (21, 22) in the region of the weld seam (23).

2. Trimming device according to claim 1, characterised in that the contour of the profile milling cutter (10) has graduations (10a) and/or projections (10b) along its rotational axis (12).

3. Trimming device according to claim 1, characterised in that the profile milling cutter (10) has several chip removing edges, and at least two cutting edges rotate around the rotational axis (12) of the profile milling cutter (10) in flying circles with differing diameters.

4. Trimming device according to claim 1, characterised in that the profile milling cutter (10) comprises at least two discs with differing diameters, and the discs carry on their circumference at least one chip removing cutting edge.

5. Trimming device according to claim 1, characterised in that the profile milling cutter (10) is formed as a one-piece rotatory basic body having graduations (10a) and/or projections (10b), and cutting edges arranged on the circumference.

6. Trimming device according to claim 1, characterised in that the trimming device (3) serves for removing the welding bead (24) on the external corner (27) of two synthetic profiles (21, 22) welded angular.

7. Trimming device according to claim 1, characterised in that the trimming device (3) has two stoppers (31, 32) arranged angular, preferably rectangular, and each of the synthetic profiles (21, 22) of the frame sits close to a stopper (31, 32).

8. Trimming device according to claim 1, characterised in that the trimming device has a working table of the frame, and the working table has two stoppers arranged angular, preferably rectangular, and each of the synthetic profiles of the frame sits close to a stopper.

9. Trimming device according to claim 1, characterised in that the trimming device (3) has a down-holding device (35) which acts essentially rectangular to the plane of the frame.

10. Trimming device according to claim 1, characterised in that the trimming device has a working table for supporting the frame, respectively the frame part, a down-holding device being provided on the working table which acts essentially rectangular to the plane of the frame.

11. Trimming device according to claim 1, characterised in that the rotational axis (12) of the profile milling cutter (10) is orientated rectangular to the plane of the frame.

12. Trimming device according to claim 1, characterised in that the trimming device (3) can be moved at least along one direction (33, 34) and thus the profile milling cutter (10) can be set against the frame (2).

13. Trimming device according to claim 1, characterised in that the trimming device (3) can be moved rectangular (33) to the plane of the frame.

14. Trimming device according to claim 1, characterised in that the trimming device (3) can be moved parallel (34) to the plane of the frame.

15. Trimming device according to claim 1, characterised in that the trimming device (3) can be moved in the direction of the rotational axis (12).

16. Trimming device according to claim 1, characterised in that the trimming device has two stoppers arranged angled and interacting with the frame, and the position of the profile milling cutter (10) may be adjustable, with regard to the stoppers (31, 32), respectively the down-holding device (35), however, when the trimming device is in use, is fixed.

17. Trimming device according to claim 1, characterised in that the trimming device has a down-holding device (35) which acts essentially rectangular to the plane of the frame, and the position of the profile milling cutter (10) relatively to the down holding device (35) may be adjustable, however, during use of the trimming device, is fixed.

18. Trimming device according to claim 1, characterised in that the trimming device has a down holding device (35) which acts essentially rectangular to the plane of the frame, and the profile milling cutter (10) can move relatively to the down holding device.

19. Trimming device according to claim 1, characterised in that the profile milling cutter (10) is arranged in such a way that it can be moved, in particular positioned, on the trimming device (10).

20. Trimming device according to claim 1, characterised in that the trimming device has a down holding device (35) which essentially rectangular to the plane of the frame, and the down-holding device (35) is held on the trimming device (3) spring-supported.

21. Trimming device according to claim 1, characterised in that the trimming device has two stoppers arranged angled and interacting with the frame, and a down holding device (35) is provided on the trimming device, and, first of all, the frame (2) is put on the stoppers (31, 32), the down-holding device (35) fixes the frame (2), and, after that, the profile milling cutter (10) removes the welding bead (24).

22. Trimming device according to claim 1, characterised in that the trimming device (3) can be moved, first of all, in one direction (34) parallel to the plane of the frame in order to put the stoppers (31, 32) arranged on the trimming device (3) close to the synthetic profiles (21, 22) of the frame (2), and, after that, the trimming device (3) can be moved rectangular (33) to the plane of the frame, removes the welding bead (24) until the down-holding device (35) is supported by the frame (2).

23. Trimming machine for synthetic frames for removing the projecting welding bead which forms on the weld seam of welded synthetic profiles, the trimming machine for synthetic frames having a trimming device according to claim 1.
